(19) United States
(12) Patent Application Publication
(10) Pub. No.: US 2021/0294933 A1
(43) Pub. Date: Sep. 23, 2021

(54) TWO-STAGE METHOD FOR DOUBLE-ROW INTELLIGENT LAYOUT OF WORKSHOP BASED ON MULTIPLE CONSTRAINTS

(71) Applicant: SOUTHWEST JIAOTONG UNIVERSITY, Chengdu (CN)

(72) Inventors: Zeqiang ZHANG, Chengdu (CN); Silu LIU, Chengdu (CN); Wei LIANG, Chengdu (CN); Chao GUAN, Chengdu (CN); Hongbin ZHENG, Chengdu (CN); Junqi LIU, Chengdu (CN); Xiaoyue FANG, Chengdu (CN)

(21) Appl. No.: 17/337,821

(22) Filed: Jun. 3, 2021

(30) Foreign Application Priority Data
Mar. 25, 2021 (CN) 202110320521.5

(51) Int. Cl. G06F 30/13; G06F 30/20

(52) U.S. Cl. CPC G06F 30/13; G06F 2111/04; G06F 30/20

(57) ABSTRACT

A two-stage method for a double-row intelligent layout of a workshop based on multiple constraints. The minimum logistics cost function of the double-row intelligent layout is established as the objective function, and the constraints of the function model are established at the same time, to generate the LP model. The initial population of facilities is generated, and the fitness value of each individual in the initial population is calculated according to the LP model, so that the fitness value is used as the current optimal solution. The individual in the initial population is continuously optimized by using the VNS and PMX technologies, and the value of the objective function and optimal sequence of the optimal solution are updated by using the elite retention strategy.

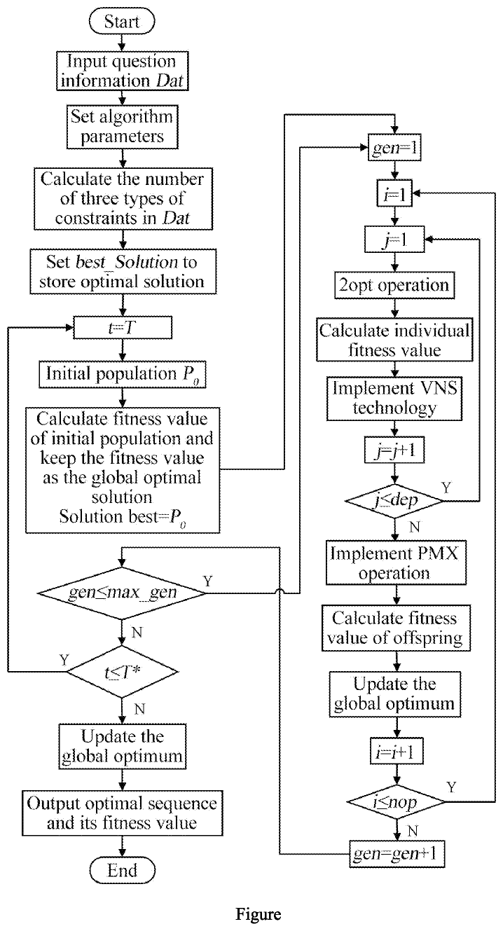

### CROSS-REFERENCE TO RELATED APPLICATIONS

This application claims the benefit of priority from Chinese Patent Application No. 202110320521.5, filed on Mar. 25, 2021. The content of the aforementioned application, including any intervening amendments thereto, is incorporated herein by reference in its entirety.

### TECHNICAL FIELD

The present application relates to facility layout technologies, and more particularly to a two-stage method for a double-row intelligent layout of a workshop based on multiple constraints.

### BACKGROUND

Facility layout problems (FLPs) are a broad and complex type of operational research problems, in which the optimal physical allocation of a pre-set number of non-overlapping facilities (such as service areas, facilities and workstations) is enabled to meet one or more goals in a given space. In a manufacturing system, facility layout and design are particularly important for reducing material handling costs, increasing productivity, effectively using existing space, adapting factories to future changes, and providing workers with a healthy, convenient and safe environment. The double-row layout problem (DRLP), as a classic problem in facility layout problems, is a non-deterministic polynomial time problem. In the DRLP, the optimal layout configuration for a group of rectangular departments or facilities is found out, and these departments or facilities are arranged along both sides of the central corridor, thereby minimizing a total material transportation cost.

The previous researches related to the DRLP mainly focused on unconstrained optimization problems, that is, under a given number of facilities, the facilities can be freely allocated at any location, thereby minimizing the total material transportation cost. Different from the single-row layout problem and the multi-row layout problem, the DRLP has the characteristic of combination of combinatorial and continuous aspects, and in view of this, it is required to determine the sequence (relative position) of the facilities in each row and the exact location (absolute position) of each facility. However, in actual situations, it is often necessary to consider the relationship between the location of the facility and the positioning sequence, which usually includes the following constraints: (1) positioning constraint: if the facility has a location that needs to be matched, it means that the facility has the positioning constraint; (2) ordering constraint: if some pre-set facilities need to be allocated in a predetermined order, it means that there is a precedence relationship between the i^{th} facility and the i^{th} facility; relationship constraint: this constraint is usually adopted in the facility layout to limit the occurrence of some special situations. These constrains can prevent the destruction of production process relationships by considering the minimum material handling costs between facilities. For example, in a flexible manufacturing system, decision makers can design two workstations to be arranged both in sequence and close arrangement. However, these constraints existing in the practical application are not taken into consideration in the existing methods, so that the existing methods generally suffer some limitations in practical applications.

### SUMMARY

An object of the present disclosure is to provide a two-stage method for a double-row intelligent layout of a workshop based on multiple constraints to solve the above problems in the prior art, in which the facilities are arranged in two rows under multiple constraints, and thus the two-stage method of the present disclosure has higher application value.

The technical solutions of the present disclosure are described as follows.

The present disclosure provides a two-stage method for a double-row intelligent layout of a workshop based on multiple constraints, comprising:

(1) establishing a minimum logistics cost function of the double-row intelligent layout as an objective function; establishing constraints of a model the minimum logistics cost function, wherein the constrains comprises a positioning constraint, an ordering constraint and a relationship constraint; and establishing a linear programming (LP) model according to the model of the minimum logistics cost function and the constraints;

(2) generating an initial population of a two-row arrangement coding sequence of facilities by using a random initialization method; calculating a fitness value of each individual in the initial population according to the LP model; and taking the fitness value as a current optimal solution; and

(3) continuously optimizing individuals in the initial population by using a variable neighborhood search (VNS) algorithm and a partially mapped crossover (PMX) algorithm, and updating a value of the objective function and an optimal sequence corresponding to an optimal solution by using an elite retention strategy.

Compared to the prior art, the present disclosure has the following beneficial effects.

In the two-stage method of the present disclosure, the minimum logistics cost is set as the objective function, and the positioning constraint, the ordering constraint, and the relationship constraint are set as the constraints of the objective function to form the LP model. At the same time, the initial population is generated by using the random initialization method, and the initial population is optimized locally according to the PMX and VNS technologies. The optimal solution of the population is established through the elite preservation strategy, and the positioning constraint, the ordering constraint and the relationship constraint of each facility are obtained through the optimal solution, and then subjected to the LP model to obtain the global optimal solution. By considering the double-row layout under multiple constraints, the method of the present disclosure can obtain a better solution in a short time, especially when dealing with a double-row layout model with multiple constraints with a scale of more than 10. The method of the present disclosure has a relatively short calculation time, which is suitable for industrial applications. Through the present disclosure, the layout design and improvement of the existing double-row layout of the production workshop and office building can be carried out, thereby improving the production efficiency.

### BRIEF DESCRIPTION OF THE DRAWINGS

The FIGURE is a flow chart of operations of a two-stage method for a double-row intelligent layout of a workshop based on multiple constraints according to an embodiment of the present disclosure.

### DETAILED DESCRIPTION OF EMBODIMENTS

The present disclosure will be further described in detail below in conjunction with the embodiments and the drawings.

In order to make the objectives, technical solutions, and advantages of the present disclosure clearer, the present disclosure will be described clearly and completely in conjunction with the accompanying drawings. Obviously, the described embodiments are merely some embodiments of the present disclosure, and are not intended to limit the disclosure. Based on the embodiments of the present disclosure, all other embodiments obtained by those of ordinary skill in the art without sparing any creative effort shall fall within the scope of the present disclosure. Therefore, the following detailed description of the embodiments provided in the accompanying drawings of the present disclosure is not intended to limit the scope of the disclosure, but merely represents selected embodiments of the present disclosure.

Term explanation: upper row and lower row. With regard to the double-row layout recited herein, the facilities are usually arranged in two rows, and the two rows are called “upper row” and “lower row” respectively.

### Embodiment

A two-stage method for a double-row intelligent layout of a workshop based on multiple constraints is provided herein (as shown in the FIGURE), which includes the following steps.

(1) An LP model is established.

With regard to the establishment of the LP model, it is necessary to first make the following assumptions about the facilities and workshop in the present disclosure.

(1.1) All facilities are rectangular and have a fixed shape.

(1.2) The area of the workshop is greater than or equal to the sum of areas of all facilities.

(1.3) All facilities must be located in the given workshop and cannot overlap with each other.

(1.4) The corridor is located on the x-axis and its width is negligible.

(1.5) The interaction point of each facility is located on the side facing the corridor.

(1.6) Material flows from a center of one facility to a center of another facility.

(1.7) The constraint scheme of the three types of constraints in the model is determined by the decision maker before the implementation of the scheme.

After the above assumptions have been made, it is required to start establishing the objective function and its constraints, where the objective function is the minimum logistics cost function, expressed as follows:

$$min {\sum }_{i = 1}^{n - 1} {\sum }_{j = i + 1}^{n} {c}_{ij} {d}_{ij} ; \qquad ( 1 )$$

where i and j both are a number of a facility, and i, j∈I, where I is a collection of n facilities. cᵢⱼ is an amount of material flow between the i^{th} facility and the j^{th} facility. dᵢⱼ is a distance between the i^{th} facility and the j^{th} facility.

The aforementioned minimum logistics cost needs to meet the following constraints.

Each facility needs to be allocated. The equation (2) indicates that each facility must be allocated and only allocated to one row, while the equation (3) indicates that if the i^{th} facility is not allocated to the k^{th} rows, xᵢₖ=0.

$$\begin{matrix}{\sum }_{k ∈ K}^{ } = 1 , \text{∀} i ∈ I ; & ( 2 ) \\ {x}_{ik} \leq M \cdot {y}_{ik} , \text{∀} i ∈ I , k ∈ K ; & ( 3 )\end{matrix}$$

where k is the row index; k∈K; K={U,L}; U, L correspond to the upper row and lower row respectively; M is a constant;

$$M = {\sum }_{i ∈ I}^{ } \{ {l}_{i} + {max}_{j ∈ I} ( {a}_{ij} ) \} ;$$

xᵢₖ represents an abscissa of the logistics interaction center of the i^{th} facility on the k^{th} row. If the i^{th} facility is not allocated to the k^{th} row, xᵢₖ=0.

The equation (4) and the equation (5) are used to avoid overlap between two adjacent facilities in the layout.

$$\begin{matrix}\frac{{l}_{i} {y}_{ik} + {l}_{j} {y}_{jk}}{2} + {a}_{ij} {z}_{ji}^{k} \leq {x}_{ik} - {x}_{jk} + M \cdot ( 1 - {z}_{ji}^{k} ) \text{∀} i , j ∈ \{ i < j \vert I \} ; \text{∀} k ∈ K ; & ( 4 ) \\ \frac{{l}_{i} {y}_{ik} + {l}_{j} {y}_{jk}}{2} + {a}_{ij} {z}_{ij}^{k} \leq {x}_{jk} - {x}_{ik} + M \cdot ( 1 - {z}_{ij}^{k} ) \text{∀} i , j ∈ \{ i < j \vert I \} ; \text{∀} k ∈ K ; & ( 5 )\end{matrix}$$

in the above-mentioned equations, l is the length of the facility. lᵢ and lⱼ are respectively a length of the i^{th} facility and a length of the j^{th} facility. yᵢₖ indicates whether the facility is allocated to the k^{th} rows. If yes, k=1; otherwise, k=0. aᵢⱼ is the minimum gap between the i^{th} facility and the j^{th} facility. zᵢⱼ^{k} is a variable of 0 or 1. If the i^{th} facility and the j^{th} facility are both allocated to the k^{th} rows, and the i^{th} facility is to the left of the j^{th} facility, zᵢⱼ^{k}=1. Otherwise, zᵢⱼ^{k}=0.

The equation (6) and the equation (7) are used to calculate a precise distance between the i^{th} facility and the j^{th} facility.

$$\begin{matrix}{d}_{ij} \geq {\sum }_{k ∈ K}^{ } {x}_{ik} - {\sum }_{k ∈ K}^{ } {x}_{jk} , \text{∀} i , j ∈ \{ i < j \vert I \} ; & ( 6 ) \\ {d}_{ij} \geq {\sum }_{k ∈ K}^{ } {x}_{jk} - {\sum }_{k ∈ K}^{ } {x}_{ik} , \text{∀} i , j ∈ \{ i < j \vert I \} . & ( 7 )\end{matrix}$$

The equation (8) and the equation (9) are used to ensure the consistency between variables yᵢₖ and zᵢⱼ^{k}.

zᵢⱼ^{k}+zⱼᵢ^{k}≤½(yᵢₖ+yⱼₖ) ∀i,j∈{i<j|I};∀k∈K (8);

zᵢⱼ^{k}+zⱼᵢ^{k}+1≥yᵢₖ+yⱼₖ ∀i,j∈{i<j|I}; ∀k∈K (9).

The equations (10)-(12) represent the range of values of the variables xᵢₖ, yᵢₖ and zᵢⱼ^{k}.

xᵢₖ≥0, ∀i∈I; k∈K (10);

yᵢₖ∈{0,1}, ∀i∈I; k∈K (11);

zᵢⱼ^{k}∈{0,1}, ∀i, j∈I; i≠j; k∈K (12).

The equation (13) takes into account the positioning constraints, that is, regardless of which row the facility is on, only its relative position on the X axis is considered.

$$\begin{matrix}M \cdot {β}_{ij} + {\sum }_{k ∈ K}^{ } {x}_{ik} \geq {\sum }_{k ∈ K}^{ } {x}_{jk} , \text{∀} i , j ∈ I ; i \neq j ; & ( 13 ) \\ {β}_{ij} + {β}_{ji} = 1 , \text{∀} i , j ∈ I ; i \neq j ; & ( 14 ) \\ {β}_{ij} ∈ \{ 0 , 1 \} , \text{∀} i , j ∈ I ; i \neq j ; & ( 15 ) \\ {\sum }_{k = 1 , k \neq i}^{n} {β}_{ki} + 1 = {p}_{i} , \text{∀} i ∈ I ; {p}_{i} \neq 0 ; & ( 16 )\end{matrix}$$

where βᵢⱼ is a variable of 0 or 1; when the logistics intersection point of the i^{th} facility is on the left of the j^{th} facility, βᵢⱼ=1; otherwise, βᵢⱼ=1.

$${\sum }_{k = 1 , k \neq i}^{n} {β}_{ki}$$

represents the number of machines to the left of the interaction point of the i^{th} facility.

$$( {\sum }_{k = 1 , k \neq i}^{n} {β}_{ki} + 1 )$$

represents a current position pᵢ of the i^{th} facility.

The equation (17) is the ordering constraint between the i^{th} facility and the j^{th} facility, and the equation (18) takes into account the situation that the i^{th} facility and the j^{th} facility are further constrained in order, that is, the two need to be set in pairs.

$$\begin{matrix}{\sum }_{k = 1 , k \neq j}^{n} {β}_{kj} - {\sum }_{k = 1 , k \neq i}^{n} {β}_{ki} \geq 1 \text{∀} i , j ∈ I ; i \neq j ; {o}_{ij} = 1 ; & ( 17 ) \\ {\sum }_{k = 1 , k \neq j}^{n} {β}_{kj} - {\sum }_{k = 1 , k \neq i}^{n} {β}_{ki} = 1 \text{∀} i , j ∈ I ; i \neq j ; {o}_{ij} = 1 ; {r}_{ij} = 1 ; & ( 18 )\end{matrix}$$

where oᵢⱼ=1 represents the i^{th} facility must be arranged before the j^{th} facility, and rᵢⱼ=1 represents that the i^{th} facility and the j^{th} facility have a priority relationship and the number of positions of the two facilities in the x-axis direction is adjacent.

The LP model is established based on the above-mentioned function and constraints. In the present disclosure, the LP model is composed of the above equation (1) and the equations (3)-(7), (10) and (13), and the additional constraints are applied to other algorithms to verify the effect of the method of the present disclosure.

(2) After the LP model is established, it is necessary to consider the establishment of random codes for the facility. In the present disclosure, the following steps are used to complete the above operations.

After the facilities are encoded, the initial population is established. In order to ensure the diversity of the population, in this embodiment, different sequences are generated according to the random initialization method to generate the initial population.

For the individuals in the established initial population, the values of yᵢₖ, zᵢⱼ^{k} and βᵢⱼ can be obtained and brought into the LP model, to calculate the fitness value. The LP model is solved by the CPLEX solver, and its solution is regarded as the current optimal solution.

(3) After calculating the current optimal solution of the initial population individuals, an overlapping mutation is performed in the initial population by using the VNS technology and PMX to generate new individuals. New values of binary variables yᵢₖ, zᵢⱼ^{k} and βᵢⱼ are obtained based on the new individuals, and the brought into the LP model, so that the LP model can be solved through the CPLEX solver. The fitness value of the new solution is compared with the current optimal solution by using the elite preservation strategy. The relatively better solution is accepted, to ensure the feasible solution of the population is optimal.

In this step, the VNS technology is performed, and then the PMX operation is performed. Each time a new individual is obtained through a step of transformation, the new individual needs to be solved, and the new solution obtained is compared with the current solution.

It should be noted that, unlike many integer problems, in this problem, the random initialization method of the individual is likely to produce an infeasible solution (scheme). Generally speaking, before calculating the fitness value of the solution, a specific procedure needs to be executed to ensure the feasibility of the solution. In our research, by checking the output value of the LP model, the feasibility of the solution can be guaranteed. When the solver can find an accurate value, the solution is feasible and the objective function value is returned. Otherwise, when the solver cannot find the exact value of the LP model, the solution is not feasible.

In this embodiment, the CPLEX solver is called to perform calculations, but it does not mean that the present disclosure can only adopt the CPLEX solver to perform calculations. For example, accurate solving software such as Gurobi can all realize the solution of the present disclosure.

The advantages of the present disclosure are illustrated by examples of international benchmark calculations below.

The constraints set in this embodiment are shown in Table 1.

TABLE 1
Constraints

| Constraint type | Specific restrictions |
|---|---|
| Positioning constraint | 3→4 |
| Ordering constraint | 9←2; 6←5 |
| Relationship constraint | 6↑5 |

In Table 1, “3→4” means that the third facility 3 must be located at the position 4. “9←2” and “6←5” mean that the ninth facility 9 must be placed before the second facility 2, and the sixth facility 6 must be placed before the fifth facility 5. “6↑5” means that the sixth facility 6 and the fifth facility 5 are arranged adjacent to each other, and they have a priority relationship.

In the method provided herein, the operating parameters are designed as follows: Max_gen=40, noP=7, dep=6*n, and thre=80. The CPLEX solver is called for calculation in the calculation process of the present disclosure. At the same time, an accurate algorithm (i.e., according to the equations (1)-(18), the CPLEX solver is directly called for calculation) is adopted as a comparative calculation method. All calculation examples were run independently 20 times.

The final results are shown in Table 2.

TABLE 2
Calculation results

| | | Smart layout method | | | | | CPLEX | | |
|---|---|---|---|---|---|---|---|---|---|
| | | | | | | Time | Objective | | |
| | | Objective function value | | | | (t/s) | function | Time | Optimal |
| Examples | Scale | Min. | Max. | Avg. | SD | Avg. | value | (t/s) | sequence |
| S9 | 9 | 1380.00 | 1380.00 | 1380.00 | 0 | 172.41 | 1380.00 | 11.52 | 9 3 5 4/ |
| | | | | | | | | | 2 7 6 1 8 |
| S9h | | 2334.50 | 2334.50 | 2334.50 | 0 | 161.61 | 2334.50 | 66.84 | 8 7 1 6 2/ |
| | | | | | | | | | 4 3 9 5 |
| S10 | 10 | 1453.00 | 1453.00 | 1453.00 | 0 | 252.85 | 1453.00 | 57.39 | 1 7 6 5 8/ |
| | | | | | | | | | 9 3 4 10 2 |
| S11 | 11 | 3570.50 | 3570.50 | 3570.50 | 0 | 292.05 | 3570.50 | 374.53 | 2 10 6 8/ |
| | | | | | | | | | 9 7 3 1 4 5 11 |
| Am12a | 12 | 1563.00 | 1563.00 | 1563.00 | 0 | 455.60 | 1563.00 | 1048.95 | 7 3 11 2 10 8/ |
| | | | | | | | | | 1 12 9 4 6 5 |
| Am12b | | 1736.50 | 1736.50 | 1736.50 | 0 | 455.36 | 1736.50 | 1686.69 | 9 12 2 6 8 10 1/ |
| | | | | | | | | | 7 3 5 4 11 |
| Am13a | 13 | 2479.50 | 2479.50 | 2479.50 | 0 | 583.33 | 2479.50 | 7859.92 | 7 10 6 5 2 1/ |
| | | | | | | | | | 9 3 11 12 4 8 13 |
| Am13b | | 2907.00 | 2907.00 | 2907.00 | 0 | 586.52 | 2907.00 | 7971.73 | 7 6 11 4 12/ |
| | | | | | | | | | 10 9 3 5 8 13 2 1 |
| Am15 | 15 | 3282.00 | 3282.00 | 3282.00 | 0 | 958.19 | — | 54000.00 | — |

In Table 2, the boundary between the upper row and the lower row of facility in the layout is represented by the symbol “/”.

It can be seen from Table 2 that, the method proposed by the present disclosure is consistent with the results of the accurate algorithm for solving the scale of 9-15. For the calculation examples respectively with a scale of 9 and 10, the use of precise algorithms has an advantage in the computing time. However, when the scale is not less than 11, the method provided herein can calculate accurate results in a short time, but the time consumption of the accurate algorithm gradually increases. When the scale reaches 13, the time required for the accurate algorithm to obtain the result is approximately 13.6 times the time required for the present disclosure. When the scale is 15, the accurate algorithm fails to obtain a result for more than 15 hours, while the present disclosure only requires 958 seconds. The above results indicate that when dealing with a large-scale DRLP model with multiple constraints, the present disclosure can accurately and quickly calculate a global optimal solution, but the accurate algorithm is difficult to effectively process.

For calculation examples with a scale greater than 20, accurate algorithms are difficult to process, but the method of the present disclosure can also be used to perform effective and fast calculations. Therefore, this embodiment also gives the following examples.

In order to analyze the implementation of the present disclosure in the case of a larger scale of the two-row layout example problem with multiple constraints, a series of experiments are conducted. For this set of examples, 15 other available benchmark examples of multi-constrained double-row layout are considered, which are selected from the 30 to 42 example data in (M. F. Anjos and Yen (2009)).

In these tests, the thirteenth facility 13 is subject to positioning constraints, and is required to be fixed in the fifth position. The twentieth facility 20 and the tenth facility 10, the eighth facility 8 and the fifteenth facility 15 are subject to ordering constraints, where the twentieth facility 20 must be located before the tenth facility 10, and the eighth facility 8 must be located before the fifteenth facility 15. In addition, it should be noted that the eighth facility 8 and the fifteenth facility 15 are restricted by the relationship. Therefore, it is not allowed to place other facilities in the middle of this pair of facilities.

The quality and efficiency of the solution are taken into account. In this experiment, the parameter combination is given as follows: Max_gen=50, noP=8, dep=6*n and thre=180.

The results obtained after solving the double-row layout example with multiple constraints are shown in Table 3. The number of facilities is coded in the instance name listed in the second column. The third column of the Table 3 lists the most well-known values of these benchmark examples. The fourth column lists the average calculation time of the solution obtained by the present disclosure. The last column lists the known optimal arrangement of the two-row layout example with multiple constraints. The results show that the method of the present disclosure is effective for solving the double-row layout with multiple constraints.

TABLE 3
Solutions of double-row layout under multiple constraints

| | | Known | Operation | |
|---|---|---|---|---|
| | | optimal | time | |
| No | Examples | solution | (t/s) | Known optimal solution sequence |
| 1 | N30_01 | 4235 | 22350.62 | 5 21 13 29 20 30 3 10 7 19 18 23 15 1 26/ |
| | | | | 2 28 6 4 14 16 27 9 11 25 22 8 12 24 17 |
| 2 | N30_02 | 11269.5 | 22364.31 | 20 17 10 6 2 21 9 25 22 16 4 14 23 15 18/ |
| | | | | 26 24 13 12 5 29 28 1 7 19 30 11 8 27 3 |
| 3 | N30_03 | 23746 | 22776.17 | 14 3 13 30 29 9 7 18 26 25 1 12 28 15 17/ |
| | | | | 20 21 27 2 4 16 10 19 11 22 23 24 8 6 5 |
| 4 | N30_04 | 30842.5 | 23556.43 | 20 19 13 14 29 21 16 6 9 7 11 1 18 17 28/ |
| | | | | 27 30 4 2 25 5 3 10 12 8 15 22 24 23 26 |
| 5 | N30_05 | 58701.5 | 24565.81 | 4 29 21 6 20 16 10 3 11 18 23 25 7 12 24/ |
| | | | | 14 9 13 28 2 5 26 30 27 19 22 17 8 15 1 |
| 6 | ste36_01 | 6135 | 45766.82 | 24 27 23 12 6 4 9 1 8 18 3 16 22 19 30 31 34 25/ |
| | | | | 26 13 11 14 5 20 10 7 15 2 17 21 28 29 32 33 36 35 |
| 7 | ste36_02 | 101392 | 46135.64 | 24 26 13 12 5 20 4 10 15 16 17 28 29 34 33 35 36 25/ |
| | | | | 21 22 11 27 6 14 23 9 1 2 18 8 7 3 19 30 32 31 |
| 8 | ste36_03 | 62358.5 | 45192.36 | 2 6 13 12 4 14 20 8 18 27 29 31 33 17 26 24 36 9/ |
| | | | | 5 11 23 1 10 7 3 15 16 28 19 30 32 34 21 22 25 35 |
| 9 | ste36_04 | 59617.5 | 47940.97 | 23 6 11 26 14 9 20 10 15 2 36 21 22 19 32 34 29 3/ |
| | | | | 27 13 12 25 24 1 4 5 7 8 18 17 28 33 31 30 16 35 |
| 10 | ste36_05 | 57381.5 | 44733.83 | 21 25 12 26 14 6 5 4 9 3 2 15 18 19 34 31 36 35/ |
| | | | | 22 24 13 11 27 23 20 1 10 7 8 16 17 28 32 33 30 29 |
| 11 | sko42_01 | 12979 | 119147.72 | 22 28 36 33 27 20 35 19 10 14 32 1 3 5 734 17 15 40 29/ |
| | | | | 23 16 13 2 30 39 21 4 26 31 24 9 18 37 12 11 |
| | | | | 38 42 8 6 25 41 |
| 12 | sko42_02 | 111164.5 | 104516.1632 | 14 31 13 28 23 4 21 27 20 26 32 19 5 3 10 24 42 |
| | | | | 25 41 17 8/ 2 11 22 39 30 35 33 18 12 36 37 38 16 40 |
| | | | | 29 7 34 9 6 1 15 |
| 13 | sko42_03 | 88831.5 | 111670.802 | 22 21 33 1 15 38 28 23 3 36 26 20 7 18 25 12 5 |
| | | | | 27 41 10 29/ 32 9 13 4 8 24 37 40 14 31 39 30 35 11 |
| | | | | 34 17 2 6 42 19 16 |
| 14 | sko42_04 | 71393 | 103379.786 | 29 7 41 17 40 11 15 31 42 38 26 3 36 39 37 23 |
| | | | | 9 33 4 1/ 6 34 13 25 12 8 20 27 10 19 18 32 21 |
| | | | | 30 5 2 28 14 35 16 24 22 |
| 15 | sko42_05 | 127718 | 112992.9043 | 32 40 13 31 8 14 12 27 35 19 18 25 41 22 |
| | | | | 24 1 28 6 16 2/ 4 9 17 29 15 11 34 20 7 |
| | | | | 33 42 10 26 21 38 3 37 39 36 5 30 23 |

Described above are only preferred embodiments of the present disclosure, which are not intended to limit the protection scope of the present disclosure. Any changes and replacements made by those skilled in the art without departing from the spirit of the disclosure should fall within the scope of the present disclosure defined by the appended claims.

What is claimed is:

1. A two-stage method for a double-row intelligent layout of a workshop based on multiple constraints, comprising:
(1) establishing a minimum logistics cost function of the double-row intelligent layout as an objective function; establishing constraints of a model of the minimum logistics cost function, wherein the constraints comprise a positioning constraint, an ordering constraint and a relationship constraint; and establishing a linear programming (LP) model according to the model of the minimum logistics cost function and the constraints;
(2) generating an initial population of a two-row arrangement coding sequence of facilities by using a random initialization method; calculating a fitness value of each individual in the initial population according to the LP model; and taking the fitness value as a current optimal solution; and
(3) continuously optimizing individuals in the initial population by using a variable neighborhood search (VNS) algorithm and a partially mapped crossover (PMX) algorithm, and updating a value of the objective function and an optimal sequence corresponding to an optimal solution by using an elite retention strategy.

2. The two-stage method of claim 1, wherein in step (1), the LP model comprises:
the minimum logistics cost function; and
the constraints of the model of the minimum logistics cost function;
wherein the minimum logistics cost function is shown as follows:
$$min {\sum }_{i = 1}^{n - 1} {\sum }_{j = i + 1}^{n} {c}_{ij} {d}_{ij} ;$$
wherein i and j both are a number of a facility; cᵢⱼ is an amount of material flow between the i^{th} facility and the j^{th} facility; and dᵢⱼ is a distance between the i^{th} facility and the j^{th} facility;
the constraints comprise a first constraint, a second constraint, a third constraint, a fourth constraint, a fifth constraint, a sixth constraint and a seventh constraint;
the first constraint is shown as follows:
xᵢₖ≤M·yᵢₖ, ∀i∈I, k∈K;
wherein xᵢₖ is an abscissa of a logistics interaction center of the i^{th} facility in the k^{th} row; yᵢₖ represents whether a facility is allocated to the k^{th} row; if yes, k=1; otherwise, k=0; M is a constant;
$$M = {\sum }_{i ∈ I}^{ } \{ {l}_{i} + {max}_{j ∈ I} ( {a}_{ij} ) \} ;$$
and I is a collection of n facilities; K={U, L}; U and L correspond to an upper row and a lower row, respectively;
the second constraint and the third constraint are shown as follows:
$$\frac{{l}_{i} {y}_{ik} + {l}_{j} {y}_{jk}}{2} + {a}_{ij} {z}_{ji}^{k} \leq {x}_{ik} - {x}_{jk} + M \cdot ( 1 - {z}_{ji}^{k} ) \text{∀} i , j ∈ \{ i < j \vert I \} ; \text{∀} k ∈ K ; \\ \frac{{l}_{i} {y}_{ik} + {l}_{j} {y}_{jk}}{2} + {a}_{ij} {z}_{ij}^{k} \leq {x}_{jk} - {x}_{ik} + M \cdot ( 1 - {z}_{ij}^{k} ) \text{∀} i , j ∈ \{ i < j \vert I \} ; \text{∀} k ∈ K ;$$
wherein the second constraint and the third constraint are provided for avoiding overlap between two adjacent facilities; lᵢ is a length of the i^{th} facility; aᵢⱼ is a minimum gap between the i^{th} facility and the j^{th} facility; zᵢⱼ^{k} represents whether the i^{th} facility and the j^{th} facility are both allocated to the k^{th} row, and the i^{th} facility is on a left of the j^{th} facility; if yes, zᵢⱼ^{k}=1; otherwise, zᵢⱼ^{k}=0;
the fourth constraint and the fifth constraint are expressed as follows:
$${d}_{ij} \geq {\sum }_{k ∈ K}^{ } {x}_{ik} - {\sum }_{k ∈ K}^{ } {x}_{jk} , \text{∀} i , j ∈ \{ i < j \vert I \} ;$$
$${d}_{ij} \geq {\sum }_{k ∈ K}^{ } {x}_{jk} - {\sum }_{k ∈ K}^{ } {x}_{ik} , \text{∀} i , j ∈ \{ i < j \vert I \} ;$$
wherein the fourth constraint and the fifth constraint are provided for calculating the distance between the i^{th} facility and the j^{th} facility;
the sixth constraint is expressed as follows:
xᵢₖ≥0, ∀i∈I; k∈K;
wherein the sixth constraint is provided for expressing a range of xᵢₖ; and
the seventh constraint is shown as follows:
$$M \cdot {β}_{ij} + {\sum }_{k ∈ K}^{ } \geq {\sum }_{k ∈ K}^{ } {x}_{jk} , \text{∀} i , j ∈ I ; i \neq j ;$$
wherein the seventh constraint is provided for constraining a location of the facility; βᵢⱼ∈{0,1}, ∀i, j∈I; i≠j and βᵢⱼ+βⱼᵢ=1, ∀i, j∈I; i≠j.

3. The two-stage method of claim 2, wherein the step (2) is performed through steps of:
establishing individuals in the initial population to obtain values of yᵢₖ, zᵢⱼ^{k} and βᵢⱼ of each individual; substituting the values of yᵢₖ, zᵢⱼ^{k} and βᵢⱼ into the LP model; and obtaining a value of the minimum logistics cost function through a CPLEX solver as the current optimal solution.

4. The two-stage method of claim 2, wherein the step (3) is performed through steps of:
subjecting individuals in the initial population to crossover and mutation to generate new individuals by using the VNS algorithm and the PMX algorithm; calculating values of yᵢₖ, zᵢⱼ^{k} and βᵢⱼ of the new individuals, and substituting the values of yᵢₖ, zᵢⱼ^{k} and βᵢⱼ of the new individuals into the LP model to calculate a value of the minimum logistics cost function as a new solution through a CPLEX solver; comparing fitness values of the new solution and the current optimal solution by using the elite retention strategy, to select a solution with a preferred fitness, thereby ensuring that the solution is optimal.

5. The two-stage method of claim 3, wherein the step (3) comprises:
subjecting individuals in the initial population to crossover and mutation to generate new individuals by using the VNS algorithm and the PMX algorithm; calculating values of yᵢₖ, zᵢⱼ^{k} and βᵢⱼ of the new individuals, and substituting the values of yᵢₖ, zᵢⱼ^{k} and βᵢⱼ of the new individuals into the LP model to calculate a value of the minimum logistics cost function through a CPLEX solver; at the same time, comparing the fitness value of the new solution and the current optimal solution by using the elite retention strategy, to select a solution with a preferred fitness, thereby ensuring that the solution is optimal.
